(19) United States
(12) Patent Application Publication
(10) Pub. No.: US 2024/0044487 A1
(43) Pub. Date: Feb. 8, 2024

(54) THROTTLE ARRANGEMENT, HEATING UNIT WITH THE THROTTLE ARRANGEMENT, METHOD FOR REGULATING A HEATING UNIT WITH THE THROTTLE ARRANGEMENT, AND ORIFICE MEASURING PATH WITH THE THROTTLE ARRANGEMENT

(71) Applicant: ebm-papst Landshut GmbH, Landshut (DE)

(72) Inventors: Jens HERMANN, Landshut (DE); Bernhard SIMON, Regensburg (DE); Stephan MICHAEL, Dresden (DE)

(21) Appl. No.: 18/255,960

(22) PCT Filed: Nov. 9, 2021
(86) PCT No.: PCT/EP2021/081099

§ 371 Date: Jun. 5, 2023

(30) Foreign Application Priority Data
Dec. 7, 2020 (DE) 102020132504.5

(51) Int. Cl. F23D 14/60; F23D 14/02

(52) U.S. Cl. CPC F23D 14/60; F23D 14/02

(57) ABSTRACT

A throttle arrangement comprising at least one first throttle element and at least one second throttle element, wherein the first throttle element and the second throttle element are connected in series, wherein the first throttle element has a first pressure loss coefficient which correlates positively with a volume flow passing through the throttle arrangement, and the second throttle element has a second pressure loss coefficient which correlates negatively with the volume flow passing through the throttle arrangement.

### CROSS-REFERENCES TO RELATED APPLICATIONS

This Application is a Section 371 National Stage Application of International Application No. PCT/EP2021/081099, filed Nov. 9, 2021, and published as WO 2022/122279 A1 on Jun. 16, 2022, and claims priority to German Application No. 10 2020 132 504.5, filed Dec. 7, 2020, the contents of each are hereby incorporated by reference in their entirety.

### BRIEF DESCRIPTION OF THE DRAWINGS

FIG. 1 illustrates a schematic structure of a heating unit according to the prior art.

FIG. 2 illustrates an exemplary variant for arranging the first throttle element and second throttle element of the throttle arrangement according to one example.

FIG. 3 illustrates a further exemplary variant for arranging the first throttle element and second throttle element of the throttle arrangement according to one example.

FIG. 4 illustrates an exemplary curve of pressure loss coefficients for single and series-connected throttle elements.

### DETAILED DESCRIPTION

The present disclosure concerns a throttle arrangement according to the preamble of claim 1. The present disclosure furthermore concerns a heating unit, a method for regulating a mixture, and an orifice measuring path.

When a medium flows through a throttle element, the pressure loss occurring downstream of the throttle element is dependent on the volume flow of the medium. The pressure loss may be given as a pressure loss coefficient of the throttle element.

Various applications are known in which there must be a precisely defined correlation between the pressure loss coefficient of the throttle element and the volume flow. For example, this is necessary in gas-fired heating units for regulating a mixture with a ratio of fuel to air, wherein a homogenous mixture with a predefined fuel-air ratio is burned in a burner.

Usually, a fan draws in the air. A constriction, for example by means of a Venturi geometry, reduces the static air pressure. The static pressure is at its minimum in the narrowest cross-section of the Venturi geometry, and is used to convey a quantity of fuel equivalent to the air flow.

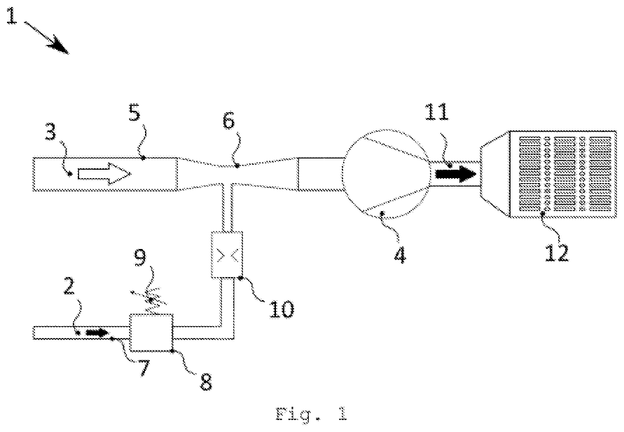

The basic structure of a heating unit working according to the prior art is shown in FIG. 1. A fuel regulator valve is equipped with a pressure regulator which reduces the pressure of the fuel on the output side of the fuel regulator valve to ambient pressure, in particular to the pressure upstream of the Venturi geometry. So that a sufficient quantity of fuel can be added to the air at all times, a main quantity throttle arranged for this in the fuel line must show the same pressure loss coefficient over a range of different volume flows as the Venturi geometry.

in the region of small and medium volume flows, however, the main quantity throttles according to the prior art have a curve of pressure loss coefficient which deviates from that of the Venturi geometry. The result is a detuning of the predefined ratio of fuel to air.

Furthermore, document EP 0 450 173 A1 discloses a device for regulating a mixture of fuel gas and air in pre-mixing gas burners with a supply air line, a gas pressure regulator and a throttle element in the gas stream, wherein gas and air flow into a mixing chamber, wherein the gas pressure regulator is an equal pressure regulator which can be controlled by the pressure in the supply air line, and wherein an air throttle is present in the air supply line, the pressure fall of which is equal to the pressure fall over the throttle element in the gas stream. The disadvantage here is that such a structure can only be used in a limited modulation range, in particular in the range in which the gas and air throttles cause the same change in pressure fall for the same percentage change in volume flow.

Furthermore, methods are known in the prior art in which the fuel pressure at the output side of the fuel regulator valve is corrected by a fixed offset. This offset is set at the fuel regulator valve and counters the behavior of the main quantity throttle. Thus the predefined ratio of fuel to air can however only be achieved in a small range of different volume flows and only with some degree of error.

An object of the present disclosure is therefore to develop a favorable throttle arrangement which can be produced at little cost and has a constant pressure loss coefficient over a wide range of different volume flows; wherein it is furthermore an object of the present disclosure to develop a heating unit in which a fuel quantity can be dosed into an air stream without errors in order to create a mixture with a defined ratio of fuel and air; wherein it is furthermore an object of the present disclosure to propose a method with which a heating unit for burning a mixture with a defined ratio of fuel and air can be safely operated.

It is furthermore an object of the present disclosure to propose an orifice measuring path with a greater validity range.

This object is achieved by the features given in claims 1, 6, 8 and 9. The respective subclaims disclose advantageous and suitable refinements.

In the context of the present disclosure, the term “Venturi geometry” means a component which conveys a fuel stream by lowering the static pressure of an air stream, and combines the air stream and fuel stream with one another.

The present disclosure provides a throttle arrangement comprising at least one first throttle element and at least one second throttle element, wherein the first throttle element and the second throttle element are connected in series, wherein the first throttle element has a first pressure loss coefficient which correlates positively with a volume flow passing through the throttle arrangement, and the second throttle element has a second pressure loss coefficient which correlates negatively with the volume flow passing through the throttle arrangement. On a change of volume flow passing through the throttle arrangement, the first throttle element and the second throttle element have respective opposite pressure loss coefficients. This allows the formation of a favorable total pressure loss coefficient of the throttle arrangement.

In an advantageous embodiment, it is provided that the first pressure loss coefficient is different from the second pressure loss coefficient. This allows optimum mutual adaptation of the pressure loss coefficients of the two throttle elements, namely the first throttle element and the second throttle element.

In an advantageous embodiment, it is provided that the first throttle element and the second throttle element are spaced apart such that the effect of the first throttle element and the effect of the second throttle element are independent of one another. Thus a mutual influencing of the two throttle elements can be avoided and an optimal effect of the two throttle elements independently of one another can be guaranteed.

In an advantageous embodiment, it is provided that the first throttle element and the second throttle element are matched to one another such that the throttle arrangement has a total pressure loss coefficient which is substantially constant over a range of different volume flows.

A substantially constant pressure loss coefficient of a throttle arrangement can always be advantageous when a defined correlation between the total pressure loss coefficient of the throttle arrangement and the volume flow passing through the throttle arrangement must be precisely defined over various volume flows passing through the throttle arrangement. This is the case for example when regulating a mixture with a fixed ratio of fuel to air in a gas-fired heating unit, since a particular ratio of fuel to air can be reliably produced. On use in an orifice measuring path similar to that of DIN EN ISO 5167-1:2003 or DIN EN ISO 5167-2:2003, the validity range of the orifice measuring path can be extended towards a lower Reynolds number and hence lower volume flows passing through the throttle arrangement.

It is particularly advantageous that the pressure loss coefficients of the series-connected throttles at least partly compensate for one another, so as to form a substantially comparable total pressure loss characteristic for different volume flows.

In an advantageous embodiment, it is provided that the range of different volume flows is delimited by a minimum volume flow and a maximum volume flow, wherein the ratio of minimum volume flow to maximum volume flow corresponds at least to the value of 1:10. Thus an optimum use of the throttle arrangement over a sufficiently wide range can be guaranteed, as may be necessary for example for use in a gas-fired heating unit.

The present disclosure furthermore concerns a heating unit for burning a mixture of fuel and air in a burner comprising a fan drawing in the air, an air line conducting an air stream, wherein the air line comprises a Venturi geometry, a fuel line conducting a fuel and opening into the air line via the Venturi geometry, wherein the fuel line comprises a fuel regulator valve, wherein the fuel regulator valve comprises a pressure regulator for reducing a fuel pressure to ambient pressure, in particular to the pressure upstream of Venturi geometry, and wherein the fuel line comprises a main quantity throttle for dosing the fuel into the air stream, wherein the main quantity throttle is configured as a throttle arrangement according to at least one of Claims 1 to 5. It is advantageous here that a flexible and specific configuration of the pressure loss coefficient of the main quantity throttle can be guaranteed so as to form a homogenous mixture with a predefined ratio of fuel to air.

In a further embodiment, it is provided that the fan is arranged upstream of the Venturi geometry, wherein the pressure regulator regulates the fuel pressure to the same value as the air pressure upstream of the Venturi geometry. It is advantageous here that this ensures that the pressure difference over the Venturi geometry corresponds to the same value as the value of the pressure difference over the main quantity throttle.

In an advantageous embodiment, it is provided that the total pressure loss coefficient of the throttle arrangement is equal to the pressure loss coefficient of the Venturi geometry. Thus a change of a volume flow passing through the Venturi geometry causes a corresponding change in the volume flow passing through the throttle arrangement in the fuel line. It is advantageous here that dosing of a predefined quantity of fuel into the air can be guaranteed so as to form a mixture with the optimum ratio of fuel to air. Thus it is possible that the burner always burns an optimal mixture and thereby can deliver an optimal heating power.

The present disclosure furthermore concerns a method for regulating a mixture of fuel and air in a burner of a gas-fired heating unit with a fan drawing in the air, an air line conducting an air stream, wherein the air line comprises a Venturi geometry, a fuel line conducting a fuel, wherein the fuel line opens into the air line via the Venturi geometry, wherein the fuel line comprises a fuel regulator valve, wherein the fuel regulator valve comprises a pressure regulator for reducing a fuel pressure to ambient pressure, in particular to the pressure upstream of Venturi geometry, and wherein the fuel line comprises a main quantity throttle comprising a throttle arrangement according to at least one of Claims 1 to 5 for dosing the fuel into the air stream, comprising the steps:
drawing in the air by means of the fan,
reducing a static pressure of the air by means of the Venturi geometry.
opening the fuel regulator valve to introduce the fuel with fuel pressure into the fuel line.
reducing the fuel pressure by means of the pressure regulator to ambient pressure, in particular to the pressure upstream of the Venturi geometry,
conveying the fuel by means of the Venturi geometry,
dosing a quantity of fuel into the air stream by means of the main quantity throttle.

This ensure that an optimal mixture of fuel and air is always available to the heating unit for burning over a range of different volume flows.

According to the present disclosure, furthermore an orifice measuring path is provided, wherein the orifice measuring path comprises a throttle arrangement according to at least one of claims 1 to 5. It is advantageous here that the validity range of an orifice measuring path, for example similar to that of DIN EN ISO 5167-1:2003, or DIN EN ISO 5167-2:2003, can be extended towards lower Reynolds numbers and hence towards lower through-flow values while retaining the accuracy of the measuring path.

Further details of the present disclosure are described in the drawings with reference to schematically illustrated exemplary embodiments.

FIG. 1 shows schematically a heating unit 1 with a burner 12 in which a mixture 11 of fuel 2 and air 3 is burned in order to generate heat. A fan 4 draws air 3 from the environment of the heating unit 1 and creates an air stream which is conducted in an air line 5. The air line 5 comprises a Venturi geometry 6. A fuel line 7 conducting a fuel 2 also opens into the Venturi geometry 6. The pressure of the pressurized fuel 2 is initially reduced to ambient pressure, in particular to the pressure upstream of the Venturi geometry, by means of a fuel regulator valve 8 comprising a pressure regulator 9. Then the fuel 2 is drawn in by the air stream via the Venturi geometry 6 and mixed with the air 3 into a mixture 11 of fuel 2 and air 3. The mixture 11 is then burned in the burner 12.

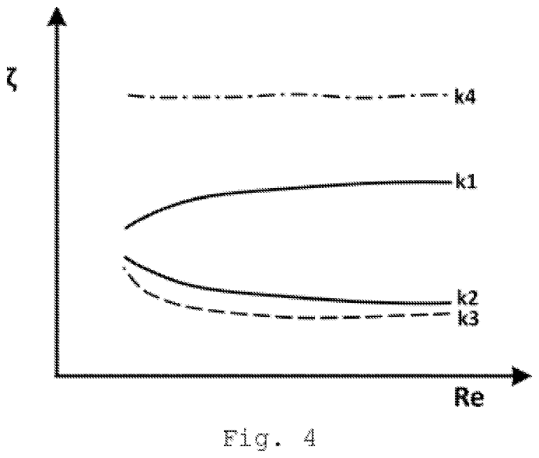

In order to allow a desired ratio of fuel 2 to air 3, a main quantity throttle 10, which supplies a defined quantity of fuel 2 to the air 3, is arranged between the fuel regulator valve 8 and the Venturi geometry 6. If the quantity of the air 3 conducted in the air line 5 changes because of the need for an increase or reduction in heating power of the heating unit 1, the quantity of fuel 2 drawn in by means of the Venturi geometry 6 also changes. In order to guarantee an always defined ratio, the main quantity choke 10 is configured as a throttle arrangement (shown in FIG. 3 and FIG. 4), wherein the throttle arrangement (shown in FIG. 3 and FIG. 4) comprises at least one first throttle element (shown in FIG. 3 and FIG. 4) and one second throttle element (shown in FIG. 3 and FIG. 4).

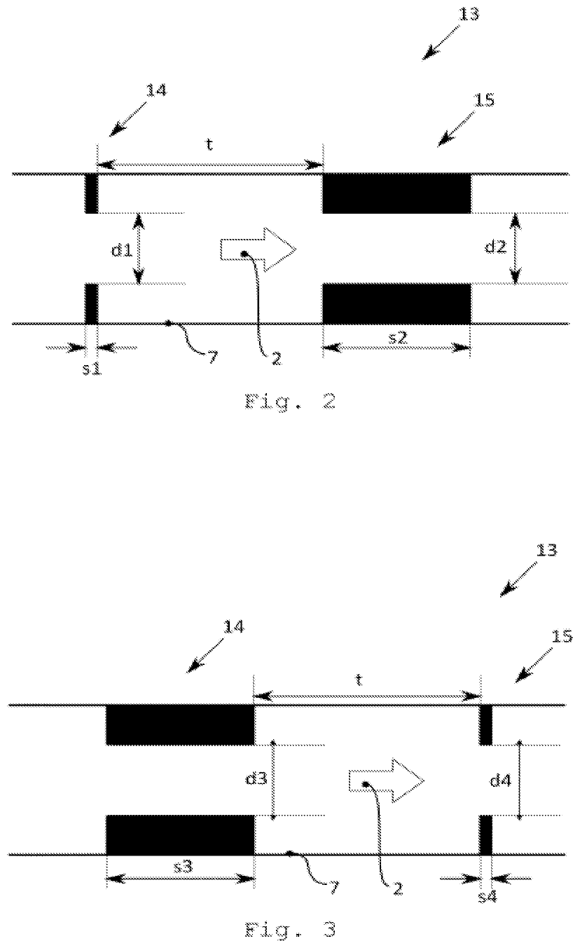

FIG. 2 shows a possible variant of a throttle arrangement 13 comprising a first throttle element 14 and a second throttle element 15. For example, a fuel line 7 is shown with fuel 2. Here, the first throttle element 14 is configured with a small throttle length s1 and a throttle diameter d1, and the second throttle element 15 with a large throttle length s2 and a throttle diameter d2. The first throttle element 14 and the second throttle element 15 are spaced apart by a distance t1, whereby they do not influence one another in their effect and throttle the stream of fuel 2 independently of one another.

FIG. 3 shows a further possible variant of the throttle arrangement 13 comprising a first throttle element 14 and a second throttle element 15. As an example, a fuel line 7 with fuel 2 is shown. Here, the first throttle element 14 is configured with a large throttle length s3 and a throttle diameter d3, and the second throttle element 15 with a small throttle length s4 and a throttle diameter d4. The first throttle element 14 and the second throttle element 15 are spaced apart by a distance t2, whereby they do not influence one another in their effect and throttle the stream of fuel 2 independently of one another.

FIG. 4 shows schematically the curve of the pressure loss coefficients ζ depending on the Reynolds number Re for the following situations:
k1 describes the curve of the pressure loss coefficient ζ for a single throttle element in which the ratio of throttle length to throttle diameter is less than one,
k2 describes the curve of the pressure loss coefficient ζ for a single throttle element in which the ratio of throttle length to throttle diameter is greater than one,
k3 describes the curve of the pressure loss coefficient ζ for a throttle element in which the ratio of throttle length to throttle diameter is equal to one, and
k4 describes the curve of the pressure loss coefficient ζ for an approximately constant total pressure loss coefficient which results as follows from the sum of a pressure loss coefficient of a first throttle element and a pressure loss coefficient of a second throttle element.

A constant total pressure loss coefficient, as shown in curve k4, can be produced according to one example if a first throttle element 14 (shown in FIGS. 2 and 3) is connected in series to a second throttle element 15 (shown in FIGS. 2 and 3). The first throttle element 14 (shown in FIGS. 2 and 3) must here have a first pressure loss coefficient which correlates positively with the volume flow passing through the throttle arrangement 13 (shown in FIGS. 2 and 3), and the second throttle element 15 (shown in FIGS. 2 and 3) must have a second pressure loss coefficient which correlates negatively with the volume flow passing through the throttle arrangement 13 (shown in FIGS. 2 and 3).

Furthermore, the first pressure loss coefficient must be different from the second pressure loss coefficient.

In addition, the first throttle element 14 (shown in FIGS. 2 and 3) and the second throttle element 15 (shown in FIGS. 2 and 3) must be spaced apart such that the effect of the first throttle element 14 (shown in FIGS. 2 and 3) and the effect of the second throttle element 15 (shown in FIGS. 2 and 3) are formed independently of one another.

Finally, the first throttle element 14 (shown in FIGS. 2 and 3) and the second throttle element 15 (shown in FIGS. 2 and 3) must be matched to one another.

Although the present invention has been described with reference to preferred embodiments, workers skilled in the art will recognize that changes may be made in form and detail without departing from the spirit and scope of the invention.

### LIST OF REFERENCE SIGNS

1 Heating unit
2 Fuel
3 Air
4 Fan
5 Air line
6 Venturi geometry
7 Fuel line
8 Fuel regulator valve
9 Pressure regulator
10 Main quantity throttle
11 Mixture
12 Burner
13 Throttle arrangement
14 First throttle element
15 Second throttle element
s1-s4 Throttle length
d1-d4 Throttle diameter
t1, t2 Distance
k1-k3 Curve of pressure loss coefficients
k4 Curve of a total pressure loss coefficient
ζ Pressure loss coefficient
Re Reynolds number

1. A throttle arrangement comprising at least one first throttle element and at least one second throttle element,
wherein the first throttle element and the second throttle element are connected in series,
wherein
the first throttle element has a first pressure loss coefficient which correlates positively with a volume flow passing through the throttle arrangement, and the second throttle element has a second pressure loss coefficient which correlates negatively with the volume flow passing through the throttle arrangement.

2. The throttle arrangement according to claim 1, wherein the first pressure loss coefficient is different from the second pressure loss coefficient.

3. The throttle arrangement according to claim 1, wherein the first throttle element and the second throttle element are spaced apart such that the effect of the first throttle element and the effect of the second throttle element on the pressure loss of a through-flowing volume flow are independent of one another.

4. The throttle arrangement according to claim 1, wherein the first throttle element and the second throttle element are matched to one another such that the throttle arrangement has a total pressure loss coefficient which is substantially constant over a range of different volume flows.

5. The throttle arrangement according to claim 1, wherein the range of different volume flows is delimited by a minimum volume flow and a maximum volume flow, wherein the ratio of minimum volume flow to maximum volume flow corresponds at least to the value of 1:10.

6. A heating unit for burning a mixture of fuel and air in a burner comprising
a fan drawing in the air,
an air line conducting an air stream,
wherein the air line comprises a Venturi geometry,
a fuel line conducting a fuel and opening into the air line via the Venturi geometry,
wherein the fuel line comprises a fuel regulator valve,
wherein the fuel regulator valve comprises a pressure regulator for reducing a fuel pressure to ambient pressure, in particular to the pressure upstream of Venturi geometry,
and wherein the fuel line comprises a main quantity throttle for dosing the fuel into the air stream,
wherein the main quantity throttle is configured as a throttle arrangement according to claim 1.

7. The heating unit according to claim 6, wherein the fan is arranged upstream of the Venturi geometry, wherein the pressure regulator regulates the fuel pressure to the same value as the air pressure upstream of the Venturi geometry.

8. The heating unit according to claim 6, wherein the total pressure loss coefficient of the throttle arrangement is equal to the pressure loss coefficient of the Venturi geometry.

9. A method for regulating a mixture of fuel and air in a burner of a gas-fired heating unit with
a fan drawing in the air,
an air line conducting an air stream,
wherein the air line comprises a Venturi geometry,
a fuel line conducting a fuel,
wherein the fuel line opens into the air line via the Venturi geometry,
wherein the fuel line comprises a fuel regulator valve,
wherein the fuel regulator valve comprises a pressure regulator for reducing a fuel pressure to ambient pressure, in particular to the pressure upstream of Venturi geometry,
and wherein the fuel line comprises a main quantity throttle comprising a throttle arrangement according to claim 1 for dosing the fuel into the air stream,
comprising the steps:
drawing in the air by means of the fan,
reducing a static pressure of the air by means of the Venturi geometry,
opening the fuel regulator valve to introduce the fuel with fuel pressure into the fuel line,
reducing the fuel pressure by means of the pressure regulator to ambient pressure, in particular to the pressure upstream of the Venturi geometry,
conveying the fuel by means of the Venturi geometry,
dosing a quantity of fuel into the air stream by means of the main quantity throttle.

10. An orifice measuring path, wherein the orifice measuring path comprises a throttle arrangement according to claim 1.
